(19) United States
(12) Patent Application Publication
(10) Pub. No.: US 2016/0292781 A1
(43) Pub. Date: Oct. 6, 2016

(54) METHOD AND SYSTEM FOR PROVIDING, CONTROLLING AND MONITORING AIR CONDITIONING, HEATING AND AIR QUALITY

(71) Applicant: Watsco Ventures LLC, Coconut Grove, FL (US)

(72) Inventors: Aaron J. Nahmad, Miami Beach, FL (US); Steven Rupp, Miami, FL (US); Andre Zdanow, Fort Lauderdale, FL (US); Ivan Rapin-Smith, Miami, FL (US); Mario A. Cruz, Miami, FL (US)

(21) Appl. No.: 15/087,149

(22) Filed: Mar. 31, 2016

Related U.S. Application Data
(60) Provisional application No. 62/140,773, filed on Mar. 31, 2015.

(51) Int. Cl. G06Q 30/06; F24F 11/00

(52) U.S. Cl. CPC G06Q 30/0645; F24F 11/0009

(57) ABSTRACT

An on-premises device that works in conjunction with systems and methods to provide atmosphere control as a service. For example, an on-premises device that works in conjunction with a system and method may provide to, control and monitor air conditioning and/or heating at a premises as a service on e.g., a pay per use and/or subscription plan. In addition to or alternatively, an on-premises device that works in conjunction with a system and method may provide air quality and comfort to a premises as a service.

### CLAIM OF PRIORITY

This application claims priority from U.S. Provisional Application No. 62/140,773, filed Mar. 31, 2015, the entirety of which is incorporated herein by reference.

### FIELD OF THE INVENTION

The disclosed embodiments relate to an on-premises device that works in conjunction with a system and method to provide to, control and/or monitor air conditioning and/or heating at a premises as a service on e.g., a pay per use and/or subscription plan. The disclosed embodiments also relate to an on-premises device that works in conjunction with a system and method to provide air quality and comfort to a premises as a service (e.g., a pay per use and/or subscription plan). Thus, the disclosed embodiments relate to and provide atmosphere control as a service.

### BACKGROUND

Currently, as a home owner, if you want to cool or heat your home you need to buy the HVAC (heating, ventilating, and air conditioning) equipment and have it installed. This scenario, however, has several shortcomings. For example, there is the large upfront cost associated with the purchasing and installation of the necessary HVAC and other equipment. Moreover, the purchaser must choose between more expensive, high efficiency units, or less expensive, but lower efficiency units—thus, possibly trading off efficiency (and more costly operating costs) for cheaper upfront costs. In addition to these upfront costs, there are the additional costs arising during the lifetime of the equipment such as e.g., the costs to maintain and/or repair the equipment. It should be appreciated that the aforementioned costs will be incurred over time particularly as the equipment ages or is exposed to weather conditions, regardless of whether the equipment is used a lot or hardly ever used.

In addition, it should be appreciated that these same problems exist for other types of residences as well as places of business and other structures requiring heating and/or air conditioning. Accordingly, there is a need and desire for a better way to heat, cool and/or regulate air quality and comfort at a premises such as e.g., a residence, place of business or other structure.

### SUMMARY OF THE INVENTION

Embodiments disclosed herein provide a method of providing atmosphere control at a premises. The method comprises providing HVAC equipment to the premises; connecting the HVAC equipment to an on-premises control/monitoring device; and controlling the HVAC equipment via the on-premises control/monitoring device in accordance with a pay per use or subscription plan.

Embodiments disclosed herein also provide a system for providing atmosphere control at a premises. The system comprises an on-premises control/monitoring device connected to HVAC equipment provided at the premises; at least one sensor in communication with the on-premises control/monitoring device; and an off-premises computing device in communication with the on-premises control/monitoring device via a network, said off-premises computing device adapted to control the HVAC equipment via the on-premises control/monitoring device in accordance with a pay per use or subscription plan.

### BRIEF DESCRIPTION OF THE DRAWINGS

FIG. 1 illustrates an example system constructed in accordance with the disclosed principles.

FIG. 2 illustrates an example of the on-premises control/monitoring device used in the FIG. 1 system and constructed in accordance with the disclosed principles.

### DETAILED DESCRIPTION

Embodiments disclosed herein provide a novel way to heat and cool a premises such as e.g., a residence, place of business or other structure that overcomes the problems with current techniques. The embodiments disclosed herein will provide air conditioning and/or heating to a premises as a service on e.g., a pay per use and/or subscription plan. The embodiments disclosed herein will also provide air quality or comfort as a service. As such, the disclosed embodiments allow the owner/leaser/operator of a premises (hereinafter referred to as a “subscriber”) to purchase e.g., a monthly subscription to get the air temperature, humidity and air quality he/she wants and when he/she needs it. Thus, the disclosed embodiments relate to and provide atmosphere control as a service.

Moreover, according to the disclosed principles, there will be no upfront costs associated with the purchasing and installation of an on-premises control/monitoring device and the necessary HVAC and other equipment disclosed herein. A service provider, such as e.g., Watsco, Inc., finances and installs the on-premises control/monitoring device and all other necessary equipment. The service provider will be responsible for maintaining and repairing the installed equipment. As such, there are no surprise maintenance or repair costs to the subscriber. Moreover, the disclosed embodiments will include diagnostics that can be monitored remotely so that preventative maintenance and repairs can be made at the appropriate time. In addition, when any of the installed equipment reaches its useful end-of-life, it is replaced with newer, state-of-the art equipment at no cost to the subscriber.

According to the disclosed principles, the subscriber will pay only for the air conditioning/heating/air quality, etc. that it requests through e.g., a pay per use and/or monthly/yearly subscription plan. The plan can be similar to a cellular phone service plan where the subscriber pays a set amount each month intended to cover the costs of the desired air conditioning or heating per month. The subscriber can be charged fees when the air conditioning and heating usage exceeds the costs of its monthly plan. Similar to a cellular phone service plan, the subscriber can have an unlimited plan where the subscriber pays one fee (determined by the service provider) and does not have to worry about exceeding its plan. Likewise, it should be appreciated that when the air conditioning and heating usage is less than the costs of its monthly plan, a rollover of unused air conditioning and heating service could also be implemented. Moreover, the subscriber can purchase add-on options to account for air quality or comfort.

There are many options available to the subscriber and to the service provider. For example, zone-based billing and control can be implemented, which would be particularly useful for premises having unused areas or areas requiring specific atmospheric conditions, areas having multiple tenants, etc. That is, atmosphere control can be provided to one or more zones within the premises in accordance with the zone-based billing plan.

In one embodiment, the service provider and the on-premises control/monitoring device could determine how to cool, heat, etc. the premises based on the subscriber's budget. For example, the service provider and the on-premises control/monitoring device could adjust the subscriber's service based on how much or little remains in the subscriber's budget for that month. Alternatively, or in addition to, the budget and/or service could be adjusted based on future weather predictions (i.e., the air or heat being currently provided can be changed in anticipation of a change in weather requiring more or less service in the upcoming future). Alternatively, or in addition to, the subscriber can be put on a budget that is changed over time based on historical usage.

System performance is continuously monitored to ensure that the subscriber is getting the air conditioning/heating/air quality it has subscribed for. In addition, diagnostic performance data from the on-premises control/monitoring device are sent to the service provider for preventive maintenance.

According to the disclosed principles, the service provider will install the on-premises control/monitoring device (as part of or in addition to the installed HVAC equipment) at each premises that, among other things, controls (using e.g., control inputs from a service provider's off-premise computer/server) and measures the subscriber's actual consumption. The measured consumption will be transmitted to the service provider's computer/server or other back office equipment and will be used as an input for monthly invoicing of the subscriber. The on-premises control/monitoring device will also measure temperature and humidity in different rooms to regulate them according to the subscriber's comfort preferences and desired energy efficiency. In one embodiment, the subscribed services can be connected to other smart devices (e.g., an air quality device, energy blinds) to create a connected premises (explained below in more detail).

In embodiments disclosed herein, the service provider will have the capability to re-configure or shut down the services provided to a subscriber if the subscriber's account is in default or behind in payments. The service provider's off-premises computer/server can remotely monitor and regulate the operation of the subscriber's on-premises equipment (via the control/monitoring device) to ensure that the equipment is being operated in an optimized manner. The equipment installed at the subscriber's premises can be used as a hub to connect with other smart devices installed at the premises. It should be appreciated that since control of the on-premises equipment is performed by an off-premises service provider computer/server (or other equipment), the delivery and monitoring of the air conditioning and/or heat cannot be tampered with by the subscriber.

It should be appreciated that the disclosed embodiments can be integrated with “utility demand response programs” which are ways for utility providers to reduce their load during peak demand times (e.g., providing a subscriber with a discount or other benefit for allowing its air conditioning to be turned off during peak demand times).

In one embodiment, the on-premises monitoring/control device is programmable (via the service provider's computer/server) to ensure that a projected bill will stay within the subscriber's pre-set budget. In addition to, or alternatively, the on-premises HVAC equipment will use variable tonnage compressors such that the right amount of air conditioning is achieved at the right times and in an efficient manner. The disclosed embodiments can integrate with smart vent technology to close or open vents automatically. It should be appreciated that the combination of smart vents and variable tonnage technology allows for optimum system efficiency.

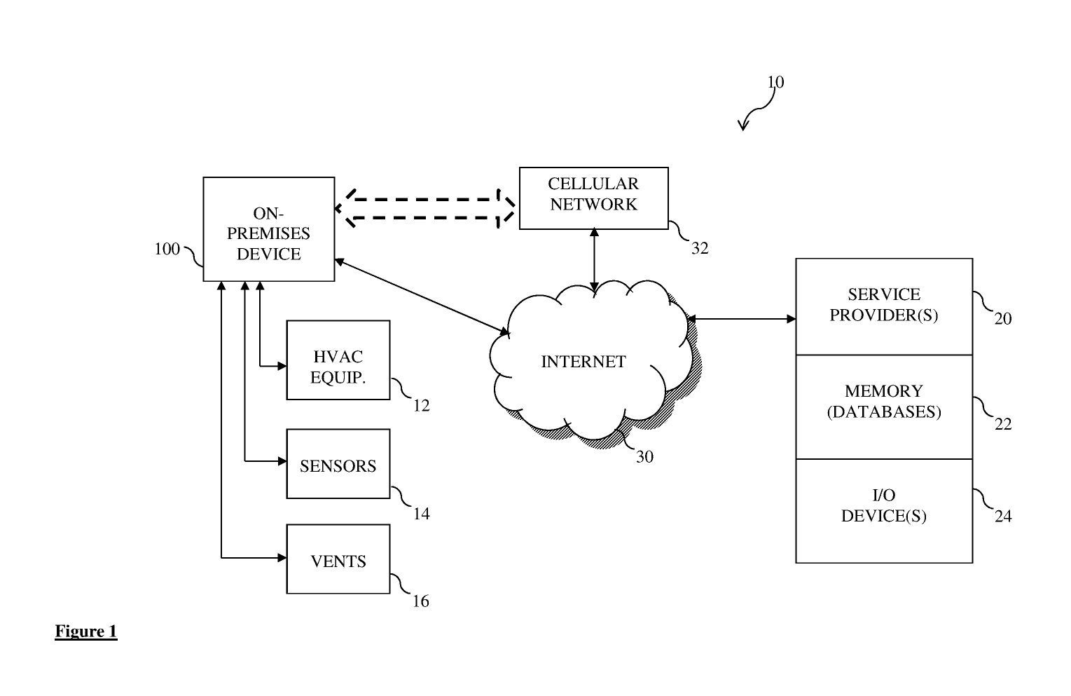

FIG. 1 illustrates an example system 10 constructed in accordance with an example embodiment disclosed herein. The system 10 comprises at least one service provider server 20 and an on-premises control/monitoring device 100 for operating embodiments disclosed herein. While FIG. 1 illustrates the use of a service provider server 20, it should be appreciated that other computing devices (e.g., personal computer, workstation, and the like) could be used to practice the embodiments disclosed herein. The system 10 also comprises HVAC equipment 12 installed at the premises. In addition, sensors 14 and/or controllable/programmable vents 16 may also be installed at the premises to provide the benefits discussed herein. The HVAC equipment 12, sensors 14 (if installed) and vents 16 (if installed) communicate with the on-premises control/monitoring device 100 in any conventional matter, including wired and wireless communication methods as discussed herein.

The above described atmosphere as a service functions are preferably implemented in software (i.e., computer instructions) that are stored in a computer readable memory and executed by a processor. To that end, the service provider server 20 includes or is connected to a memory 22 for storing computer instructions required to implement the control, monitoring and invoicing functions described herein and to store the various databases and subscriber information used during the processes described herein. Each server 20 can access the on-premises control/monitoring device 100, and be accessed by the on-premises control/monitoring device 100, via a cellular network 32 or other wireless network 30 (shown as the Internet in this example). Each server 20 can include input/output devices 24 such as displays, scanners, printers, etc. The on-premises control/monitoring device 100 will be capable of wireless communications such as e.g., Internet-based communications, and other “out of band” communications (e.g., cellular) for subscribers that do not have Internet access.

In one embodiment, the on-premises control/monitoring device 100 is a “smart device” capable of communicating with the service provider server 20 via wireless communications (e.g., cellular communications, WLAN, Wi-Fi, etc.). The disclosed smart device 100 and sensors 14 will have the monitoring and control capabilities for the installed HVAC equipment 12 discussed herein and will communicate the necessary data to the service provider(s), which can then use the received data for invoicing and control of the premises equipment. In another embodiment, a control/monitoring device 100 can be integrated with an external compressor unit installed at the premises. With the device 100 installed on variable tonnage compressor, remote tonnage changes (mechanically/electronically) are possible.

In another embodiment, the installed on-premises control/monitoring device 100 (e.g., smart device, smart thermostat, sensors, other IOT devices) can work on its own meshed network (like 6LoWPAN or ZigBee) and/or on Wi-Fi and/or via Bluetooth (to connect with devices worn by a subscriber). FIG. 1 shows the on-premises control/monitoring device 100 having connections to the HVAC equipment 12 (e.g., variable tonnage compressor), sensors 14 and controllable vents 16. It should be appreciated that the disclosed system 10 is not to be limited to these specific devices and that any other devices for monitoring and/or controlling the atmosphere within the premises could be included in the system 10 such as the devices discussed below.

In one embodiment using variable tonnage compressors (also known as inverter technology), a subscriber's service can be expanded or contracted based on its needs and not simply based on the size of the premises. Thus, it will be easy to remotely fine tune a subscriber's service, something that is not currently achievable. As such, the disclosed embodiments can provide “on-demand” atmospheric service in a quick and efficient manner.

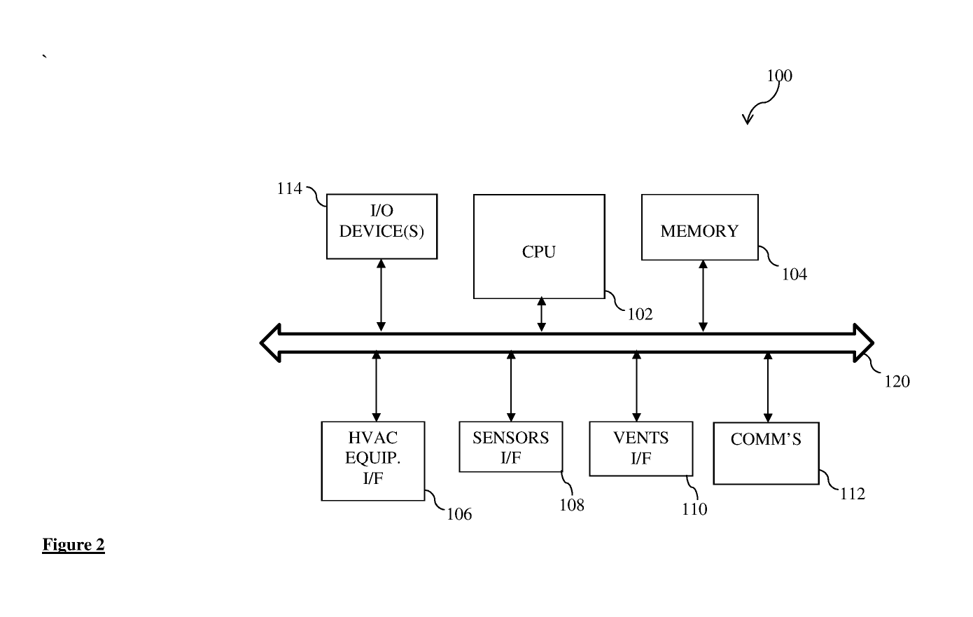

FIG. 2 illustrates an example block diagram of the on-premises control/monitoring device 100 constructed in accordance with an example embodiment disclosed herein. The on-premises control/monitoring device 100 comprises a processor (CPU) 102, memory 104 and input/output devices 114 communicating over a bus 120, allowing the device 100 to be programmed and accessed on site. As understood by those skilled in the art, the above described atmosphere as a service functions are preferably implemented in software (i.e., computer instructions) that are stored in the computer readable memory 104 and executed by the processor 102. In addition, the on-premises control/monitoring device 100 may comprise one or more communication mechanisms 112, allowing it to be remotely programmed, monitored and/or diagnosed, as well as to receive wireless inputs from a device within the premises. One suitable communication mechanism 112 is a Bluetooth communication device. The on-premises control/monitoring device 100 may also comprise one or more interfaces 106, 108, 110 for communicating with external equipment such as e.g., the HVAC compressor (e.g., using interface 106), sensors (e.g., using interface 108) and programmable/controllable vents (e.g., using interface 110).

The on-premises control/monitoring device 100 will be able to diagnose system components (e.g., HVAC 12) by itself and report diagnostic performance data back to the service provider (e.g., to the service provider server 20), which will then use the data to schedule preventive maintenance and repairs. In one embodiment, the service provider can set up a call center to process and respond to technical problems with the subscriber's equipment. This way, the service provider can provide proactive service, which should prevent major problems and service interruption. This is a major advantage over existing HVAC systems, which do not include digital interfaces for providing digital diagnostics in this manner. It should be appreciated that the on-premises control/monitoring device 100 can be used with older technology via a mechanical/switched based interface for obtaining the diagnostic information described herein.

The disclosed embodiments will work with smart devices of any type. In one embodiment, the on-premises control/monitoring device 100 will utilize geofencing to determine that someone is within the premises. For example, the on-premises control/monitoring device 100 can input data from a user-wearable device or some other type of sensor that will output an indication to the device 100 (e.g., via a Bluetooth communication) that someone is in the premises. This information could be used to modify the air temperature/quality in a specific room or zone to a desired level based on which room or zone is actually being occupied. Other sensors could be used e.g., to determine when lights are turned on and used as an indication that, among other things, someone is in the premises. The on-premises control/monitoring device 100 can also be programmed to receive inputs from or to send control outputs to energy blinds, programmable vents, indoor air quality devices (IAQ), lights, passive devices worn by a subscriber to measure the subscriber's comfort (e.g., devices that measure body temperature and body moisture), etc.

The foregoing examples are provided merely for the purpose of explanation and are in no way to be construed as limiting. While reference to various embodiments is made, the words used herein are words of description and illustration, rather than words of limitation. Further, although reference to particular means, materials, and embodiments are shown, there is no limitation to the particulars disclosed herein. Rather, the embodiments extend to all functionally equivalent structures, methods, and uses, such as are within the scope of the appended claims.

Additionally, the purpose of the Abstract is to enable the patent office and the public generally, and especially the scientists, engineers and practitioners in the art who are not familiar with patent or legal terms or phraseology, to determine quickly from a cursory inspection the nature of the technical disclosure of the application. The Abstract is not intended to be limiting as to the scope of the present inventions in any way.

What is claimed is:

1. A method of providing atmosphere control at a premises, said method comprising:
providing HVAC equipment to the premises;
connecting the HVAC equipment to an on-premises control/monitoring device; and
controlling the HVAC equipment via the on-premises control/monitoring device in accordance with a pay per use or subscription plan.

2. The method of claim 1, wherein the controlling step comprises providing a communication between the on-premises control/monitoring device and an off-premises device controlled by a service provider associated with the subscription plan.

3. The method of claim 2, wherein the communication is used by the service provider to determine whether the HVAC equipment is being controlled in accordance with the subscription plan.

4. The method of claim 1, wherein the HVAC equipment is adjusted to control a temperature within the premises.

5. The method of claim 1, wherein the HVAC equipment is adjusted to control air quality within the premises.

6. The method of claim 1, wherein the HVAC equipment is controlled to provide atmosphere control in one or more zones of the premises in accordance with a zone-based subscription plan.

7. The method of claim 1, wherein the subscription plan comprises a subscriber budget and the HVAC equipment is controlled such that the atmosphere control is adjusted to stay within the subscriber budget.

8. The method of claim 1, further comprising:
inputting, via the on-premises control/monitoring device, data from at least one sensor within the premises; and
adjusting, via the on-premises control/monitoring device, the temperature and/or air quality within the premises based on the data from the at least one sensor.

9. The method of claim 8, wherein the adjusting step comprises controlling one of controllable vents, indoor air quality devices, or lights within the premises.

10. The method of claim 1, further comprising:
inputting, via the on-premises control/monitoring device, diagnostic data concerning the HVAC equipment; and
transmitting, from the on-premises control/monitoring device, the diagnostic data to an off-premises device controlled by a service provider associated with the pay per use or subscription plan.

11. The method of claim 10, further comprising scheduling maintenance for the HVAC equipment based on the diagnostic data.

12. A system for providing atmosphere control at a premises, said system comprising:
an on-premises control/monitoring device connected to HVAC equipment provided at the premises;
at least one sensor in communication with the on-premises control/monitoring device; and
an off-premises computing device in communication with the on-premises control/monitoring device via a network, said off-premises computing device adapted to control the HVAC equipment via the on-premises control/monitoring device in accordance with a pay per use or subscription plan.

13. The system of claim 12, wherein the HVAC equipment is controlled to provide atmosphere control in one or more zones of the premises in accordance with a zone-based subscription plan.

14. The system of claim 12, wherein the HVAC equipment is adjusted to control a temperature and/or air quality within the premises.

15. The system of claim 12, wherein the HVAC equipment comprises a variable tonnage HVAC unit and a tonnage of the HVAC unit is adjusted to control a temperature and/or air quality within the premises.

16. The system of claim 12, wherein the on-premises control/monitoring device uses an input from the at least one sensor to adjust the temperature and/or air quality within the premises based on the data from the at least one sensor.

17. The system of claim 16, further comprising a controllable device within the premises, said controllable device being selected from the group consisting of controllable vents, indoor air quality devices, and lights.

18. The system of claim 17, wherein the on-premises control/monitoring device is adapted to adjusts the temperature and/or air quality within the premises by controlling the controllable device.

19. The system of claim 12, wherein the on-premises control/monitoring device is adapted to input diagnostic data from the HVAC equipment and transmit the diagnostic data to the off-premises computing device.

20. The system of claim 19, wherein the off-premises computing device is configured to schedule maintenance for the HVAC equipment based on the diagnostic data.
